(19) United States
(12) Patent Application Publication
(10) Pub. No.: US 2005/0195702 A1
(43) Pub. Date: Sep. 8, 2005

(54) Yoke plate for optical pick-up actuator, combination structure of yoke plate with suspension PCB, and optical pick-up actuator including the same

(76) Inventors: Goo Hong, Kyunggi-do (KR); Jang-Young Im, Kyunggi-do (KR); Do-Sun Nam, Kyunggi-do (KR)

Correspondence Address: GOTTLIEB RACKMAN & REISMAN PC, 270 MADISON AVENUE, 8TH FLOOR, NEW YORK, NY, 100160601, US

(21) Appl. No.: 10/903,646

(22) Filed: Jul. 30, 2004

(30) Foreign Application Priority Data
Mar. 3, 2004 (KR) 2004-14379

(51) Int. Cl. G11B 7/00

(52) U.S. Cl. 369/44.14; 369/44.15

(57) ABSTRACT

Disclosed herein are a yoke plate for optical pick-up actuators, a combination structure of a suspension PCB and a yoke plate, and an optical pick-up actuator comprising the structure. The yoke plate comprises a rear yoke at the distal end of one side of the yoke plate, and the rear yoke has damping-gel fillers for attenuating a partial resonance of the suspension wires. The yoke plate is simplified in construction by supporting the suspension PCB using the rear yoke instead of a conventional wire holder, so that assembly process can be simplified and the manufacturing costs can be reduced. The suspension PCB is combined with the yoke plate by bonding or soldering instead of screw fastening, so that the suspension PCB can be combined with the yoke plate without displacement or distortion. The optical pick-up actuator with the combination structure can be provided by a simplified assembly process and reduced manufacturing costs.

### BACKGROUND OF THE INVENTION

1. Field of the Invention

The present invention relates to a yoke plate for optical pick-up actuators, a combination structure of the yoke plate with a suspension PCB, and an optical pick-up actuator including the combination structure. More particularly, the present invention relates to a yoke plate for optical pick-up actuators simplified in construction by supporting suspension wires with a rear yoke of the yoke plate instead of a conventional wire holder, thereby eliminating the wire holder, a combination structure of a suspension PCB fixed by other means instead of screw fastening in order to solve problems caused by the screw fastening, and an optical pick-up actuator including the combination structure.

2. Description of the Related Art

FIG. 1 is a perspective view of a conventional optical pick-up actuator in a combined state, and FIG. 2 is an exploded perspective view of the conventional optical pick-up actuator.

Referring to FIGS. 1 and 2, a combination structure of a yoke plate for the conventional optical pick-up actuator and a suspension PCB will now be described.

The conventional optical pick-up actuator comprises a yoke plate 10, a bobbin 20, suspension wires 30, a wire holder 40 and a suspension PCB 50.

The yoke plate 10 is provided with an opening 11 through which an optical beam can pass, spacer yokes 12 and 13 bent upwardly at either side of the opening 11 for preventing magnetic field dispersion, magnet fixing yokes 16 and 17 bent upwardly, respectively, outside of the spacer yokes 12 and 13 for fixing magnets 14 and 15, a wire holder support yoke 18 upwardly protruded at one side of the magnet fixing yokes 16 and 17 for supporting the wire holder 40. The magnets 14 and 15 are fixed at predetermined surfaces of the magnet fixing yokes 16 and 17, respectively. The wire holder 40 and the suspension PCB 50 are sequentially disposed to fix to the wire holder support yoke 18 by fastening a screw S.

The bobbin 20 is provided with an objective lens 21 on the top thereof, wound with focusing coils 23 around outer periphery thereof, wound with tracking coils 22 around both distal end thereof, and attached with coil PCBs 24 at front and rear sides thereof. The bobbin 20 is mounted such that it can be suspended on the yoke plate 10 by the suspension wires 30.

Each of four suspension wires 30 is electrically connected to the coil PCBs 24 at one end of the suspension wire and connected to the suspension PCB 50 at the other end while being supported in the wire holder 40. The wire holder 40 acts to perform a buffing support for the suspension wires through a damping-gel filled groove 42 filled with damping gel 41 thereby attenuating a partial resonance of the suspension wires 30 and to fix the suspension PCB 50 for applying an electric signal to the suspension wires 30.

When the electric current induced as the electrical signal from the suspension PCB 50 is applied to the focusing coil 22 and tracking coil 23 through the suspension wires 30, the induced electric current performs a mutual operation with the magnets 14 and 15 fixed to the magnet fixing yokes 16 and 17, generating an electromagnetic force, which drives tracking and focusing operation of the objective lens 21. Here, the space yokes 12 and 13 prevent the magnetic field from being dispersed.

In the conventional optical pick-up actuator as shown in FIGS. 1 and 2, since the suspension PCB is fastened to the wire holder using a screw, assembly of the suspension PCB is inconvenient and is not precise due to displacement of the suspension PCB during the screw fastening. Further, when the suspension PCB is fixed using the screw fastening, torque of the screw fastening causes distortion of the suspension PCB, thereby generating errors in operation of the optical pick-up actuator.

### SUMMARY OF THE INVENTION

The present invention has been made to solve the above problems, and it is an object of the present invention to provide a yoke plate for optical pick-up actuators, which supports suspension wires and a suspension PCB using a rear yoke instead of a conventional wire holder in order to simplify construction of an optical pick-up actuator with the wire holder eliminated, thereby providing a simplified assembly process and reduced manufacturing costs of the optical pick-up actuator.

It is another object of the present invention to provide an optical pick-up actuator, of which the suspension PCB is fixed by other means, preferably bonding or soldering, instead of screw fastening, thereby solving the problems caused by the screw fastening.

In accordance with another aspect of the present invention, there is provided a combination structure of a yoke plate with a suspension PCB, wherein the yoke plate comprises, at the distal end of one side of the yoke plate, a rear yoke having damping-gel fillers for performing a buffing support for the suspension wires thereby attenuating a partial resonance of the suspension wires, and is combined, at an outer surface of the rear yoke, with a suspension PCB for applying an electric signal to the suspension wires passing through the damping-gel fillers by bonding.

In accordance with another aspect of the present invention, there is provided a combination structure of a yoke plate with a suspension PCB, wherein the yoke plate comprises, at the distal end of one side of the yoke plate, a rear yoke having damping-gel fillers for performing a buffing support for suspension wires thereby attenuating a partial resonance of the suspension wires, and is combined, at an outer surface of the rear yoke, with a suspension PCB for applying an electric signal to the suspension wires passing through the damping-gel fillers by soldering.

In accordance with another aspect of the present invention, there is provided an optical pick-up actuator, comprising: a yoke plate comprising, at the distal end of one side thereof, a rear yoke having damping-gel fillers; a bobbin provided with an objective lens on the top of the bobbin and wound with focusing coils and tracking coils around the side thereof; magnets fixed to the yoke plate, the magnets cooperating with the tracking and focusing coils to generate an electromagnetic force; a suspension PCB combined with the rear yoke of the yoke plate by bonding; and suspension wires supported to be buffed by the damping-gel filler of the yoke plate, each suspension wire being electrically connected to the bobbin and to the suspension PCB at opposite ends of the suspension wire.

In accordance with yet another aspect of the present invention, there is provided an optical pick-up actuator, comprising: a yoke plate comprising, at a distal end of one side thereof, a rear yoke having damping-gel fillers; a bobbin installed with an objective lens on a top portion of the bobbin and wound with focusing coils and tracking coils around a side thereof; magnets fixed to the yoke plate, the magnets cooperating with the tracking and focusing coils to generate an electromagnetic force; a suspension PCB combined with the rear yoke of the yoke plate by soldering; and suspension wires supported to be buffed by the damping-gel fillers of the yoke plate, each suspension wire being electrically connected to the bobbin and to the suspension PCB at opposite ends of the suspension wire.

### BRIEF DESCRIPTION OF THE DRAWINGS

The foregoing and other objects and features of the present invention will be more clearly understood from the following detailed description taken in conjunction with the accompanying drawings, in which:

FIG. 1 is a perspective view of a conventional optical pick-up actuator in a combined state;

FIG. 2 is an exploded perspective view illustrating a combination structure of the yoke plate for the optical pick-up actuator and a suspension PCB;

FIG. 3 is a perspective view of a yoke plate for an optical pick-up actuator in accordance with an embodiment of the present invention;

FIG. 4 is a perspective view of a yoke plate for an optical pick-up actuator in accordance with another embodiment of the present invention;

FIGS. 5 and 6 are a perspective view and a cross-sectional view illustrating a combination structure of the suspension PCB and the yoke plate by bonding in accordance with the present invention, respectively; and

FIG. 7 is a cross-sectional view illustrating a combination structure of the suspension PCB and the yoke plate by soldering in accordance with the present invention.

### DESCRIPTION OF THE PREFERRED EMBODIMENTS

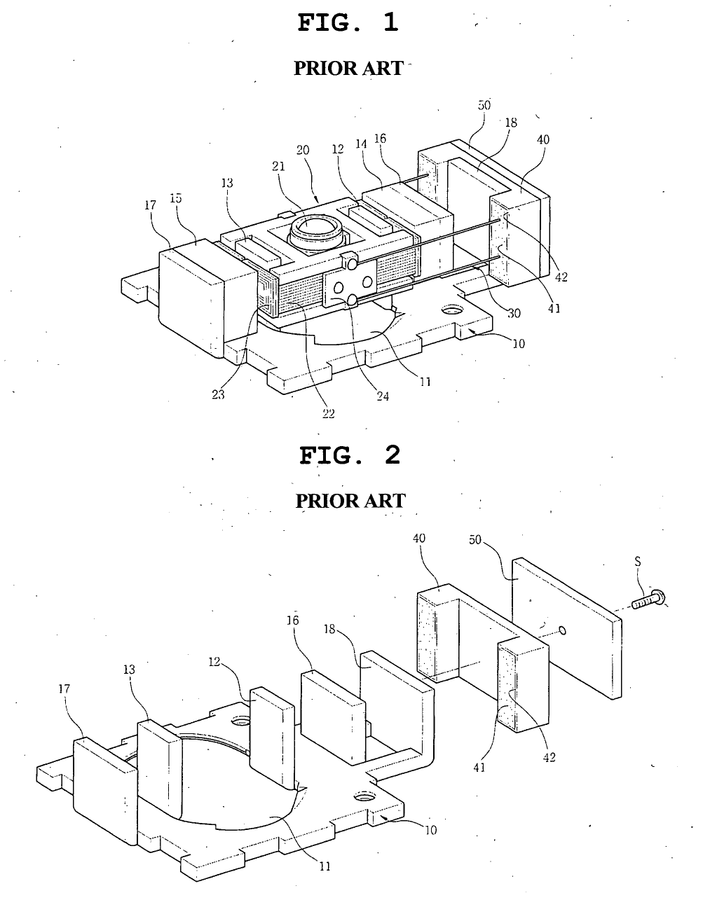

Preferred embodiments of the present invention will now be described in detail with reference to the accompanying drawings. For convenience, the same elements as those of the conventional optical pick-up actuator will be denoted by the same reference numerals in FIGS. 1 and 2.

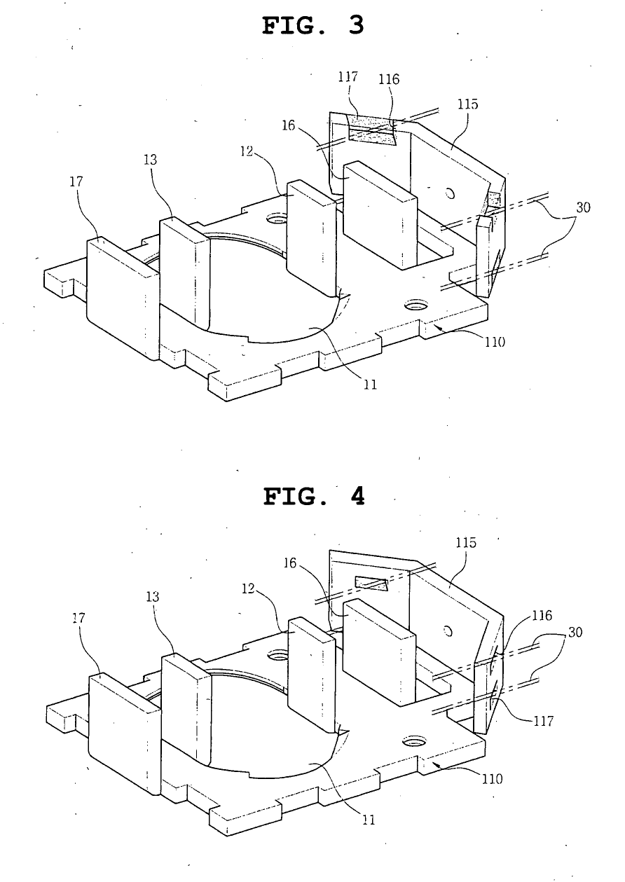

FIG. 3 is a perspective view of a yoke plate for optical pick-up actuator in accordance with an embodiment of the present invention.

Referring to FIG. 3, similar to the conventional construction, a yoke plate 110 according to the present invention is provided with an opening 11 through which an optical beam can pass, spacer yokes 12 and 13 bent upwardly at both sides of the opening 11 for preventing magnetic field dispersion, and magnet fixing yokes 16 and 17 bent upwardly, respectively, at outer side of the spacer yokes 12 and 13 for fixing magnets 14 and 15. Further, the yoke plate 110 of the present invention is provided with a rear yoke 18 bent upwardly at the distal end of one side of the yoke plate. The rear yoke 18 is provided with damping-gel fillers 116 for performing a buffing support for the suspension wires 30 thereby attenuating the partial resonance of suspension wires 30.

The subject matter of the present invention is directed to construction of the rear yoke 115, and other components are well known in the art. Thus, except the construction of the rear yoke 115, various modifications can be allowed corresponding to the kind of optical pick-up actuator to which the yoke plate is applied, and it should be understood that the modifications do not influence the spirit of the present invention set forth in the claims of the invention.

The rear yoke 115 replaces the conventional wire holder 40 and is provided with the damping-gel fillers 116 replacing the damping-gel filled groove 42 of the conventional wire holder 40. That is, the conventional wire holder 40 can be removed by providing the damping-gel fillers 116 for the rear yoke 115.

The damping-gel fillers 116 are formed of spaces symmetrically disposed at upper and lower portions of either side of the rear yoke 115, respectively, such that four suspension wires 30 can pass through. The spaces are filled with a high viscosity damping-gel 117 using a dispenser after passing the suspension wires 30 through the spaces. Specifically, as shown in FIG. 3, the damping-gel fillers 116 may be formed of openings at the upper and lower portions of either side of the rear yoke. Further, depending on passing positions of the suspension wires 30, as shown in FIG. 4, the damping-gel fillers 116 may be formed of perforations at the middle portions of either side thereof, and additionally, various modifications can be applicable. Further, the damping-gel fillers 116 may have a rectangular shape or a circular shape.

Additionally, the suspension PCB 50 of the conventional optical pick-up actuator is combined with the wire holder 40, whereas a suspension PCB 150 of the preset invention may be combined with the outer surface of the rear yoke 115 using various means, preferably bonding or soldering.

As described above, the yoke plate for the optical pick-up actuator of the present invention comprises, at the distal end of one side of the yoke plate, the rear yoke 115 provided with the damping-gel fillers 116 for performing all functions of the conventional wire holder. Thus, the conventional wire holder is not required in the present invention, so that a simplified assembly process, reduced manufacturing costs, and a small-sized optical pick-up actuator can be obtained.

A combination structure of the suspension PCB and the yoke plate of the present invention will now be described as follows.

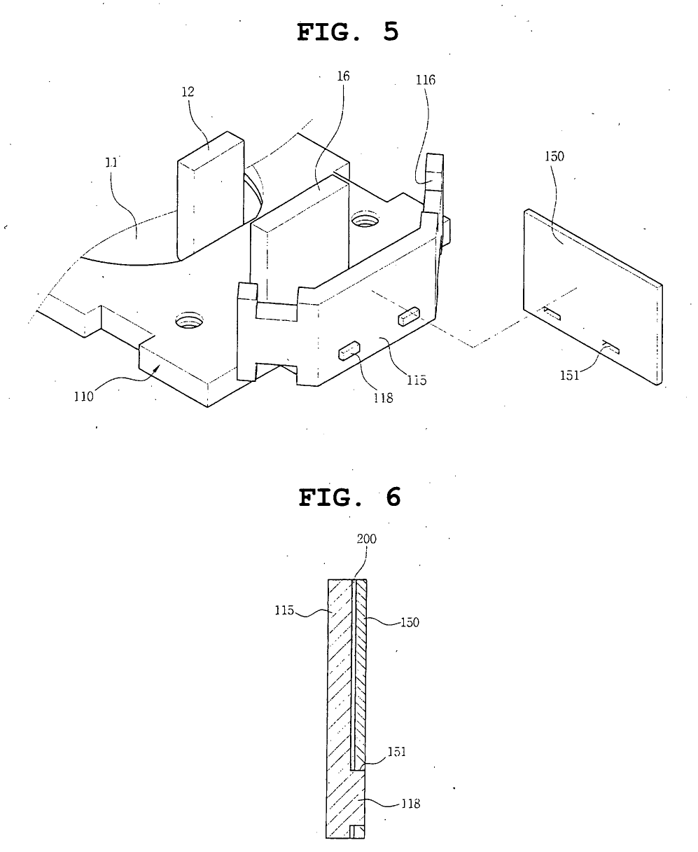

FIG. 5 is a perspective view of an embodiment of the combination structure of the suspension PCB 150 and the yoke plate 110 of the present invention, and FIG. 6 is a cross-sectional view illustrating the suspension PCB 150 and the yoke plate 110 fixed to each other by bonding.

Referring to FIGS. 5 and 6, in the embodiment of the invention, the yoke plate 110 comprises, at the distal end of one side thereof, the rear yoke 115 provided with the damping-gel filler 115 for performing a buffing support for the suspension wires 30 thereby attenuating the partial resonance of suspension wires 30, and is combined, at the outer surface of the rear yoke 115, with the suspension PCB 150 for applying an electric signal to the suspension wires 30 passing through the damping-gel fillers 116 by bonding.

The embodiment is characterized in that the suspension PCB 150 is combined with the outer surface of the rear yoke 115 by bonding. Specifically, after being applied with an adhesive by a proper means, the outer surface of the rear yoke is mounted with the suspension PCB 150. Comparing the embodiment with the prior art, the suspension PCB 50 is combined with the wire holder 40 in the conventional structure, whereas the suspension PCB 150 is combined with the rear yoke 115 in the embodiment. Thus, as the wire holder is not required, a low-priced and small-sized optical pick-up actuator can be provided. Further, in the prior art, the suspension PCB 50 is fastened thereto with a screw S, whereas suspension PCB 150 is combined with the rear yoke 115 by a bonding portion 200. Thus, the present invention can prevent problems caused by the fastening of the screw S, such as displacement of the suspension PCB during the screw fastening or distortion of the suspension PCB due to torque from the screw fastening.

Meanwhile, as described above, the damping-gel fillers 116 of the rear yoke 115 may be formed of the openings at the upper and lower portions of either side of the rear yoke or of the perforations at the middle portions of either side of the rear yoke. In addition, in order to allow easy bonding of the suspension PCB 150, as shown in FIG. 6, the rear yoke 115 may be provided with at least one combining protrusion 118 at the outer surface thereof and the suspension PCB 150 may be provided with at least one combining hole 151 to be combined with the combining protrusion 118. The combination using the combining protrusion 150 and the combining hole 151 prevents the suspension PCB 150 from moving, thereby enabling easy combination by bonding.

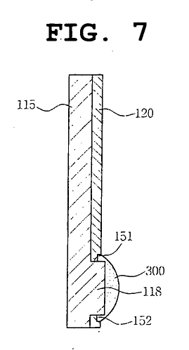

FIG. 7 illustrates another embodiment of the combination structure of the suspension PCB 150 and the yoke plate 110 combined with each other by soldering.

In the embodiment, the yoke plate 110 comprises, at the distal end of one side of the yoke plate, the rear yoke 115 provided with the damping-gel fillers 115 for performing a buffing support for the suspension wires 30 thereby attenuating the partial resonance of suspension wires 30, and is combined, at the outer surface of the rear yoke 115, with the suspension PCB 150 for applying the electric signal to the suspension wires 30 passing through the damping-gel fillers 116 by soldering.

As is apparent from the above construction, the embodiment of the invention is characterized in that the suspension PCB 150 is combined with the outer surface of the rear yoke 115 by soldering. Thus, as the suspension PCB 150 is formed on the rear yoke 115 provided with the damping-gel fillers 116, so that the conventional wire holder is not required.

Here, as described above, the damping-gel fillers 116 of the rear yoke 115 may be formed of the openings at the upper and lower portions of either side of the rear yoke or of the perforations at middle portions of either side of the rear yoke.

The soldering process of the present invention will now be described.

At first, the rear yoke 115 is provided with at least one combining protrusion 118 at the outer surface of the rear yoke 115 plated with tin. Then, the suspension PCB 150 is provided with at least one combining hole 151 to be combined with the combining protrusion 118. Subsequently, a substrate protection coating around the combining hole 151 is removed to expose a landing portion 152.

After the suspension PCB 150 is attached to the rear yoke 115 by inserting the combining hole 151 of the suspension PCB into the combining protrusion 118 of the rear yoke, the combining hole 151 and combining protrusion 118 is soldered to form a soldering portion 300. Here, the combining hole 151 and the combining protrusion 118 may be modified to have various shapes, including a semispherical embossing structure. The combination of the combining hole 151 and combining protrusion 118 not only enables easy soldering, but also prevents the suspension PCB 150 from moving.

Meanwhile, as for the soldering portion 300, although Sn-37Pb solder alloys with properly combined electrical, chemical, physical, thermal and mechanical properties can be employed, their uses cause environmental problems due to the lead. Thus, preferably, leadless soldering or soldering with N₂ gas may be used.

Unlike the conventional Sn-37Pb, the leadless solder does not use the lead, and requires principle conditions that it should employ a material which do not having a detrimental effect on the environment and that a condition for combining with the matrix or flux should be identical to that of the Sn-37Pb alloys or better. Further, including proper electrical and thermal conductivities, it should have a similar melting point to that of the conventional Sn-37Pb solder and two phase-coexistence region of liquid and solid phases of 10° C. or less in order to reduce defects in the combined part. Further, a good wettability, reliability and mechanical properties corresponding to those of the Sn-37Pb solder should be maintained. Additionally, the soldering alloys of the invention have a lower price compared with the Sn-37Pb solder. Under these conditions, the present invention replaces Sn-37Pb solder preferably with the leadless solders, such as Sn—Ag based alloys, Sn—Ag—Bi based alloys, Ag—Zn based alloys, Sn—Cu based alloys, etc.

Further, soldering with N₂ gas is a soldering process using an inert gas, such as N₂ With this soldering process, since oxygen is reduced in concentration during the soldering process, oxidation can be prevented, thereby achieving a good wettability using a flux having a weak soldering property.

An embodiment of an optical pick-up actuator having the rear yoke as described above and the combination structure of the rear yoke and the suspension PCB will now be described with reference to FIGS. 1 to 7.

The optical pick-up actuator according to the present invention comprises: the yoke plate 110 comprising, at the distal end of the one side of the yoke plate, the rear yoke 115 provided with the damping-gel fillers 116; the bobbin 20 installed with an objective lens 21 on the top of the bobbin and wound with the focusing coils 23 and the tracking coils 22 around the side thereof; magnets 14 and 15 fixed to the yoke plate, the magnets cooperating with the tracking and focusing coils to generate an electromagnetic force; the suspension PCB 150 combined with the rear yoke 115 of the yoke plate by the bonding portion 200; and the suspension wires 30 supported to be buffed by the damping-gel fillers 116 of the yoke plate, each suspension wire 30 being electrically connected to the bobbin 20 and to the suspension PCB 30 at opposite ends of the suspension wire.

As is clearly understood from the above construction, the optical pick-up actuator of the present invention is characterized in that the rear yoke 115 of the yoke plate 110 performs the functions of the wire holder eliminated in the present invention, and in that the suspension PCB is combined with the rear yoke 115 by bonding. Thus, there can be provided the optical pick-up actuator simplified in the assembly process by eliminating the wire holder and solving the problems caused by the screw fastening.

Another embodiment of an optical pick-up actuator will now be described with reference to FIGS. 1 to 7.

The optical pick-up actuator according to the present invention comprises: the yoke plate 110 comprising, at the distal end of the one side thereof, the rear yoke 115 provided with the damping-gel fillers 116; the bobbin 20 installed with an objective lens 21 on the top of the bobbin and wound with the focusing coils 23 and the tracking coils 22 around the side thereof; magnets 14 and 15 fixed to the yoke plate, the magnets cooperating with the tracking and focusing coils to generate an electromagnetic force; the suspension PCB 150 combined with the rear yoke 115 of the yoke plate by the soldering portion 300; and the suspension wires 30 supported to be buffed by the damping-gel fillers 116 of the yoke plate, each suspension wire 30 being electrically connected to the bobbin 20 and to the suspension PCB 30 at opposite ends of the suspension wire.

As is apparent from the above construction, in the optical pick-up actuator of the present invention, the rear yoke of the yoke plate performs the same function as that of the conventional wire holder eliminated in the present invention, and the suspension PCB is combined with the rear yoke of the yoke plate by soldering, preferably leadless soldering or soldering with N₂ gas. Although the optical pick-up actuator set forth above is a symmetrical type optical pick-up actuator, the present invention can also be applied to a non-symmetrical optical pick-up actuator. Since the non-symmetrical optical pick-up actuator has the same characteristics as those of the symmetrical optical pick-up actuator, detailed description thereof will be omitted.

Meanwhile, although the optical pick-up actuator with the tracking and focusing coils wound around the side of the bobbin is described in the above description, without being limited to this construction, the present invention can be applied to an optical pick-up actuator having a substrate patterned with the tracking coils and the focusing coils.

As is apparent from the description, in accordance with the present invention, the optical pick-up actuator is provided with the rear yoke formed with the damping-gel fillers, thereby eliminating the conventional wire holder. Thus, the assembly process can be simplified and the manufacturing costs can be reduced.

Further, in the combination structure of the yoke plate and the suspension PCB and in the optical pick-up actuator having the structure, the suspension PCB is combined with the yoke plate by bonding or soldering instead of screw fastening, so that the suspension PCB can be easily combined with the yoke plate without displacement or distortion.

It should be understood that the embodiments and the accompanying drawings as described above have been described for illustrative purposes and the present invention is limited by the following claims. Further, those skilled in the art will appreciate that various modifications, additions and substitutions are allowed without departing from the scope and spirit of the invention as set forth in the accompanying claims.

1. A yoke plate for optical pick-up actuators, being provided with a bobbin suspendibly mounted by suspension wires,
wherein the yoke plate comprises, at a distal end of one side of the yoke plate, a rear yoke having damping-gel fillers for performing a buffing support for the suspension wires thereby attenuating a partial resonance of suspension wires.

2. The yoke plate as set forth in claim 1, wherein the damping-gel fillers are formed of openings at upper and lower portions of either side of the rear yoke.

3. The yoke plate as set forth in claim 1, wherein the damping-gel fillers are formed of perforations at middle portions of either side of the rear yoke.

4. A combination structure of a yoke plate with a suspension PCB,
wherein the yoke plate comprises, at a distal end of one side thereof, a rear yoke having damping-gel fillers for performing a buffing support for suspension wires thereby attenuating a partial resonance of the suspension wires, and is combined, at an outer surface of the rear yoke, with a suspension PCB for applying an electric signal to the suspension wires passing through the damping-gel fillers by bonding.

5. The combination structure as set forth in claim 4, wherein the damping-gel fillers are formed of openings at upper and lower portions of either side of the rear yoke.

6. The combination structure as set forth in claim 4, wherein the damping-gel fillers are formed of perforations at middle portions of either side of the rear yoke.

7. The combination structure as set forth in claim 4, wherein the rear yoke is provided with at least one combining protrusion at an outer surface thereof, and the suspension PCB is provided with at least one combining hole to be combined with the combining protrusion.

8. A combination structure of a yoke plate with a suspension PCB,
wherein the yoke plate comprises, at a distal end of one side thereof, a rear yoke having damping-gel fillers for performing a buffing support for the suspension wires thereby attenuating a partial resonance of the suspension wires, and is combined, at an outer surface of the rear yoke, with a suspension PCB for applying an electric signal to the suspension wires passing through the damping-gel fillers by soldering.

9. The combination structure as set forth in claim 8, wherein the damping-gel fillers are formed of openings at upper and lower portions of either side of the rear yoke.

10. The combination structure as set forth in claim 8, wherein the damping-gel fillers are formed of perforations at middle portions of either side of the rear yoke.

11. The combination structure as set forth in claim 8, wherein the rear yoke is provided with at least one combining protrusion at the outer surface thereof, and the suspension PCB is provided with at least one combining hole to be combined with the combining protrusion.

12. The combination structure as set forth in claim 11, wherein the combining hole and the combining protrusion are soldered to form a combining portion.

13. The combination structure as set forth in claim 12, wherein the soldering comprises leadless soldering or soldering using N₂ gas.

14. An optical pick-up actuator, comprising:
a yoke plate comprising, at a distal end of one side thereof, a rear yoke having damping-gel fillers;
a bobbin installed with an objective lens on a top of the bobbin and wound with focusing coil and tracking coil around a side of the bobbin;
magnets fixed to the yoke plate, the magnets cooperating with the tracking and focusing coils to generate an electromagnetic force;
a suspension PCB combined with the rear yoke of the yoke plate by bonding; and
suspension wires supported to be buffed by the damping-gel filler of the yoke plate, each suspension wire being electrically connected to the bobbin and to the suspension PCB at opposite ends of the suspension wire.

15. The combination structure as set forth in claim 14, wherein the damping-gel fillers are formed of openings at upper and lower portions of either side of the rear yoke.

16. The combination structure as set forth in claim 14, wherein the damping-gel fillers are formed of perforations at middle portions of either side of the rear yoke.

17. The combination structure as set forth in claim 14, wherein the rear yoke is provided with at least one combining protrusion at the outer surface thereof, and the suspension PCB is provided with at least one combining hole to be combined with the combining protrusion.

18. An optical pick-up actuator, comprising:
a yoke plate comprising, at a distal end of the one side of the yoke plate, a rear yoke having damping-gel fillers;
a bobbin installed with an objective lens on a top of the bobbin and wound with focusing coils and tracking coils around a side of the bobbin;
magnets fixed to the yoke plate, the magnets cooperating with the tracking and focusing coils to generate an electromagnetic force;
a suspension PCB combined with the rear yoke of the yoke plate by soldering; and
suspension wires supported to be buffed by the damping-gel fillers of the yoke plate, each suspension wire being electrically connected to the bobbin and to the suspension PCB at opposite ends of the suspension wire.

19. The optical pick-up actuator as set forth in claim 18, wherein the damping-gel fillers are formed of openings at upper and lower portions of either side of the rear yoke.

20. The optical pick-up actuator as set forth in claim 18, wherein the damping-gel fillers are formed of perforations at middle portions of either side of the rear yoke.

21. The optical pick-up actuator as set forth in claim 18, wherein the rear yoke is provided with at least one combining protrusion at the outer surface thereof, and the suspension PCB is provided with at least one combining hole to be combined with the combining protrusion.

22. The optical pick-up actuator as set forth in claim 21, wherein the combining hole and the combining protrusion are soldered to form a soldering part.

23. The optical pick-up actuator as set forth in claim 22, wherein the soldering comprises leadless soldering or soldering using N₂ gas.
